(19) United States
(12) Patent Application Publication
(10) Pub. No.: US 2013/0073226 A1
(43) Pub. Date: Mar. 21, 2013

(54) Abnormal Pressure Real-Time Monitoring and High Speed Recording Device

(71) Applicant: Ming-Kung Yang, Taipei City (TW)

(72) Inventor: Ming-Kung Yang, Taipei City (TW)

(21) Appl. No.: 13/574,760

(22) PCT Filed: Jun. 10, 2010
(86) PCT No.: PCT/CN2010/073779

§ 371 Date: Jul. 23, 2012

(51) Int. Cl. G01L 9/00

(52) U.S. Cl. CPC G01L 9/00
USPC 702/50

(57) ABSTRACT

An abnormal pressure real-time monitoring and high speed recording device is disclosed. It operates essentially by first using a pressure sensor to convert various pressures (e.g., liquid pressure, air pressure or oil pressure) to the weak voltage signal within 0.0001 second, and then, through a pressure signal amplifying module, inputting the readable signal respectively to a pressure surge detecting module, a negative pressure detecting module and a pressure alarm upper/lower limit module in order to detect the occurrence of abnormal signals due to high speed surge pressure, negative pressure or exceeding of upper/lower pressure limit and the like. In case the detected signal exceeds the criteria value, it immediately awakes a microprocessor within 0.0001 second to perform continuous signal pressure reading at 0.001 second and save to the memory, and then sends the alarm message to a remote monitoring device by way of a network module or else directly controls the in-field equipment for adequate emergent processes. Upon detecting the disappearance of abnormal signals by the pressure surge detecting module, negative pressure detecting module and pressure alarm upper/lower limit detecting module, it terminates the actions of pressure value reading and signal storage and then controls the microprocessor to enter into a sleeping mode to achieve the purpose of power saving.

### BACKGROUND OF THE INVENTION

1. Field of the Invention

The present invention generally relates to an abnormal pressure real-time monitoring and high speed recording device. In particular, the present invention concerns a pressure detecting device applied onto a battery-enabled abnormal pressure real-time monitoring and high speed recording device, which is mainly able to monitor in real time the liquid pressure, gas pressure, oil pressure or any other pressure inside a closed space such as a pipeline or a tank, and to real-time detect whether the pressure is abnormal within 0.0001 second, thereby functioning as a microprocessor-equipped high speed (within 0.001 second) activating, alarming, recording and controlling mechanism.

2. Description of Related Art

In pipelines commonly used for water, oil or gas supplies, the occurrence of high speed water pressure, oil pressure or gas pressure is not rare, which frequently causes the internal pressure of the pipeline or tank to dramatically fluctuate to a positive pressure surge of 3 to 10 times of normal pressure or a negative pressure surge within an extremely short period of time (less than 0.001 second), indicating an important factor in terms of pipeline or tank breakage problems. However, general pressure sensing indicators, recorders or controllers may be unable to sense/record a signal up to 0.001 second, so it is impossible to clearly assert whether such a pipeline or tank breakage problem is indeed caused by abnormal pressures. Accordingly, for business facilities as well as maintenance and construction companies of water supply, oil supply or gas supply, it is usually unable to effectively find out the real reason once water, oil or gas pipeline damages do occur, so such annoying situations repeatedly happen.

Therefore, with regards to limitations in these general pressure sensing indicators, recorders and controllers, some companies apply a combination of pressure sensing components capable of sensing up to 0.001 second, microprocessor and software to form a sensing and recording device in order to achieve the purpose of continuous monitoring operations. Although such a solution can deal with the previously encountered problems in monitoring operations, the premises of continuous monitoring may still derive the following drawbacks:

1. Seeing that such general pressure sensing indicators, recorders or controllers as well as microprocessors need to incessantly detect and record, they are inevitably restricted to locations capable of providing sufficient electric power, thus that comprehensive utilization is not applicable.

2. To solve the issue of electric power supply for the microprocessor, the microprocessor may be driven and activated at certain fixed time points to detect and record the pressure values. Whereas, despite that such an approach of fixed-time detection may overcome the issue of power consumption, in case the pressure abnormality problems occur in the duration outside of the fixed time points, the information regarding to such abnormal pressures would be missed so the detection function thereof may not be effective.

As such, improvements on the aforementioned issues are still needed.

### SUMMARY OF THE INVENTION

The present invention provides an abnormal pressure real-time monitoring and high speed recording device. The present invention can monitor and process in real time the liquid pressure, gas pressure or oil pressure or any other pressure existing in a closed space like a pipeline or tank, and immediately determine whether the detected pressure is abnormal thereby acting as a criteria to awaken the microprocessor. In this way, it is possible to significantly improve the drawbacks of massive consumptions in both electric power and memory capacity for high speed scanning and recording processes with conventional microprocessors, and the greatly saved electric power can be alternatively used for sustaining long time operations thereby facilitating cost reductions.

To achieve the above-said purposes, the present invention discloses an abnormal pressure real-time monitoring and high speed recording device, characterized in comprising:

a pressure sensor, converting the pressure to a voltage signal;

a pressure signal amplifying module, connected to a pressure surge detecting module in order to amplify the voltage signal converted by the pressure sensor thereby converting to a readable signal level;

a pressure surge detecting module, connected to the pressure signal amplifying module and a microprocessor in order to filter pressure level, pressure amplitude, and to detect the occurrence and elimination of positive/negative pressure slope, as well as to adjust and set the pressure level, amplitude, slope and slope change;

a microprocessor, connected to the pressure signal amplifying module and the pressure surge detecting module, and, upon detecting an abnormal pressure signal by the pressure surge detecting module, awakened to activate in real time so as to read high speed continuous pressure values and save them in the memory.

Herein it further comprises a timing module, connected to the microprocessor and setting the pressure recording and detecting period in order to allow the microprocessor to process the signal inputted by the pressure signal amplifying module and to read the pressure values at fixed time points thereby determining the occurrence of a pressure alarm, thus immediately saving the pressure values in the memory in case that the pressure exceeds the alarm settings.

Herein it further comprises a network module, connected to the microprocessor in order to allow the alarm message to be transferred to a remote monitoring device through a wireless network or a wired network.

Herein the pressure surge detecting module includes a pressure level detecting module, a pressure amplitude detecting module and a positive/negative pressure slope detecting module.

Herein the pressure level detecting module is a pressure level detecting module for filtering the low pressure measurement range, and the pressure amplitude detecting module is a pressure amplitude detecting module for filtering the small-valued fluctuation and noise. Moreover, the positive/negative pressure slope detecting module is a positive/negative pressure slope detecting module for detecting the positive/negative pressure slope and slope change thereby generating a triggered signal and filtering the signal of low slope change.

Herein the pressure surge detecting module is a detecting module for high speed scanning pressure signals, which enables a detecting rate of smaller than 0.0001 second per cycle and a recording rate of lower than 0.001 second per cycle.

An abnormal pressure real-time monitoring and high speed recording device is also disclosed, characterized in comprising:

a pressure sensor, converting the pressure to a voltage signal;

a pressure signal amplifying module, connected to a pressure surge detecting module in order to amplify the voltage signal converted by the pressure sensor thereby converting to a readable signal level;

a pressure surge detecting module, connected to the pressure signal amplifying module and a microprocessor in order to detect the occurrence and elimination of positive/negative pressure slope, as well as to adjust the filtered pressure level, amplitude and the magnitude of the detected slope and slope change;

a negative pressure detecting module, installed between the pressure signal amplifying module and the microprocessor to set the negative pressure criteria value, and capable of detecting the pressure to determine whether the criteria value is exceeded thereby further awakening the microprocessor to activate;

a microprocessor, connected to the pressure signal amplifying module and the pressure surge detecting module, and, upon detecting an abnormal pressure signal by the pressure surge detecting module and the negative pressure detecting module, awakened to activate in real time so as to read high speed continuous pressure values and save them in the memory.

Herein the pressure surge detecting module includes a pressure level detecting module, a pressure amplitude detecting module and a positive/negative pressure slope detecting module.

An abnormal pressure real-time monitoring and high speed recording device is also disclosed, characterized in comprising:

a pressure sensor, converting the pressure to a voltage signal;

a pressure signal amplifying module, connected to a pressure surge detecting module in order to amplify the voltage signal converted by the pressure sensor thereby converting to a readable signal level;

a pressure surge detecting module, connected to the pressure signal amplifying module and a microprocessor in order to detect the occurrence and elimination of positive/negative pressure slope, as well as to adjust the pressure high/low level and the magnitude of the slope change;

a pressure alarm upper/lower limit detecting module, installed between the amplifying module and the microprocessor to set the pressure alarm upper/lower limit criteria value, and capable of detecting the pressure to determine whether the criteria value is exceeded thereby further triggering the microprocessor to activate;

a microprocessor, connected to the pressure signal amplifying module and the pressure surge detecting module and the pressure alarm upper/lower limit detecting module, and, upon detecting an abnormal pressure signal by the pressure surge detecting module and the pressure alarm upper/lower limit detecting module, awakened to activate in real time so as to read high speed continuous pressure values and save them in the memory.

Herein the pressure surge detecting module includes a pressure level detecting module, a pressure amplitude detecting module and a positive/negative pressure slope detecting module.

Through the aforementioned structure, the abnormal pressure real-time monitoring and high speed recording device according to the present invention can implement the following technical effects:

1. The present invention can monitor and process in real time the pressure in a closed space such as a pipeline or a tank, and determine whether the detected pressure exceeds the criteria value in order to awaken the microprocessor to enable the high speed activation alarm, record and control mechanism.

2. The microprocessor of the present invention is in a stand-by sleeping mode under normal conditions. In case that a high speed surge pressure, negative pressure, or condition indicating the upper/lower pressure limit is exceeded is detected, it is possible to awaken the microprocessor within 0.0001 second to send out an alarm and record the pressure waveform at a high speed of 0.001 second, thus greatly improving the problems of massive consumption in both electric power and memory capacity for high speed scanning and recording with conventional microprocessors.

3. The present invention allows the use of 5AH lithium batteries for continuous applications of long duration lasting at least 3˜5 years, so the pressure monitoring and recording locations need not electric power supply. In this way, it is possible to facilitate installation cost reductions for pressure monitoring on important pipelines and tanks or the like and acquire high speed surge records which are crucial to pipeline security issues.

4. The present invention can be comprehensively applied to various facilities equipped with the closed space such as gas pipelines, oil pipelines, water supply pipelines, storage tanks and so forth, allowing 0.0001 second real-time monitoring and high speed pressure change recording at 0.001 second.

### BRIEF DESCRIPTION OF THE DRAWINGS

FIG. 1 shows an installation diagram for the abnormal pressure real-time monitoring and high speed recording device according to the present invention;

FIG. 2 shows a first architecture diagram for the abnormal pressure real-time monitoring and high speed recording device according to the present invention;

FIG. 3 shows a second architecture diagram for the abnormal pressure real-time monitoring and high speed recording device according to the present invention;

FIG. 4A shows a flowchart of pressure surge detection for the abnormal pressure real-time monitoring and high speed recording device according to the present invention;

FIG. 4B shows a flowchart of pressure alarm upper/lower limit detection for the abnormal pressure real-time monitoring and high speed recording device according to the present invention;

FIG. 4C shows a flowchart of negative pressure detection for the abnormal pressure real-time monitoring and high speed recording device according to the present invention;

FIG. 4D shows a flowchart of fixed-time pressure detection for the abnormal pressure real-time monitoring and high speed recording device according to the present invention;

FIG. 5A shows a diagram of pressure detection filtering for the abnormal pressure real-time monitoring and high speed recording device according to the present invention;

FIG. 5B shows a diagram of pressure detection filtering for the abnormal pressure real-time monitoring and high speed recording device according to the present invention;

FIG. 5C shows a diagram of pressure detection filtering for the abnormal pressure real-time monitoring and high speed recording device according to the present invention; and

FIG. 5D shows a diagram of pressure surge triggering for the abnormal pressure real-time monitoring and high speed recording device according to the present invention.

### DETAILED DESCRIPTION OF THE PREFERRED EMBODIMENTS

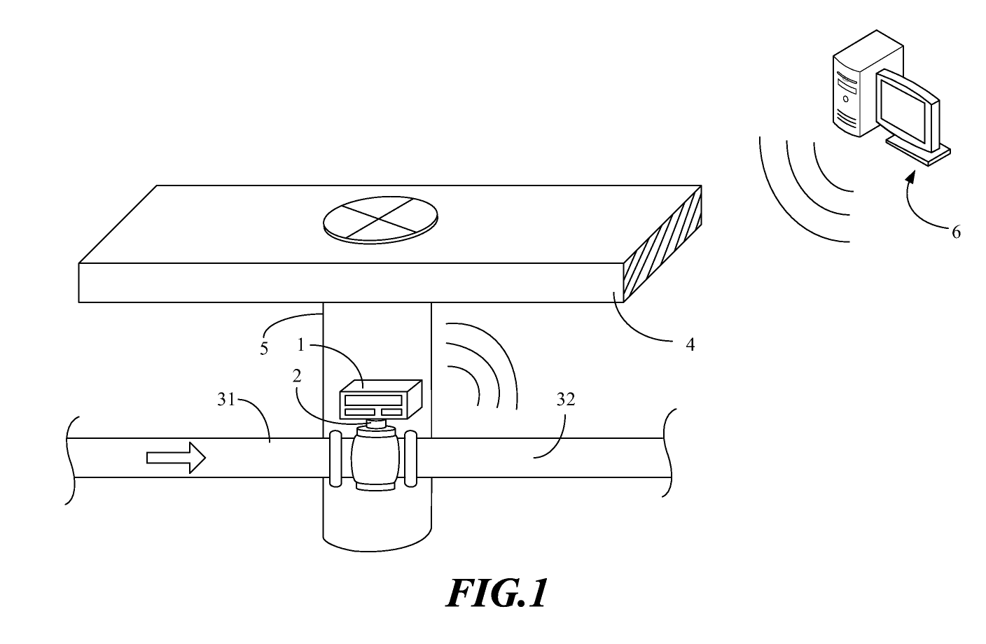

Refer initially to FIG. 1, wherein an installation diagram for the abnormal pressure real-time monitoring and high speed recording device according to the present invention is shown. The abnormal pressure real-time monitoring and high speed recording device 1 as shown is connected to a closed space like a pipeline or a tank and so forth, and forms a tri-channeled structure along with two pipelines 31, 31 by means of a connector 2; moreover, the abnormal pressure real-time monitoring and high speed recording device 1 is installed inside a manhole 5 extending to the ground 4.

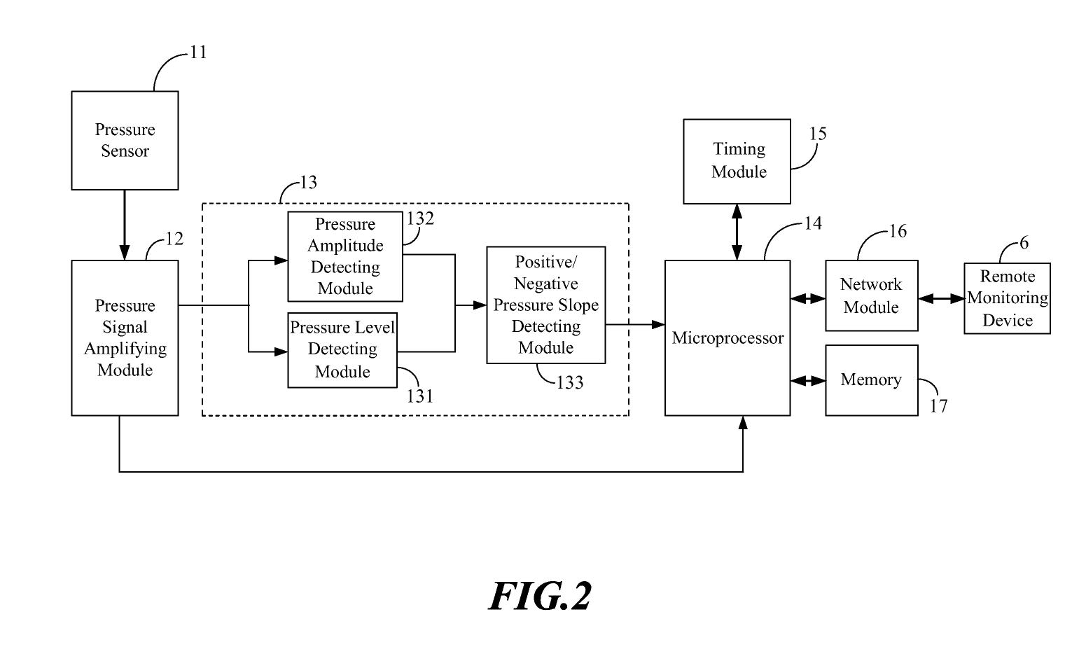

Refer next to FIG. 2, wherein a first architecture diagram for the abnormal pressure real-time monitoring and high speed recording device according to the present invention is shown, essentially comprising:

a pressure sensor 11, connected to a pressure signal amplifying module 12 to convert the pressure in the pipeline 31, 31 (see FIG. 1) to the weak voltage signal within 0.0001 second, in which the pressure sensor 11 is a pressure sensing component capable of sensing the liquid pressure, air pressure, oil pressure or other pressures;

a pressure signal amplifying module 12, connected to a pressure surge detecting module 13 and a microprocessor 14, thereby amplifying the voltage signal converted by the pressure sensor 11 in order to convert to the readable signal level;

a pressure surge detecting module 13, including a pressure amplitude detecting module 132, a pressure level detecting module 131 and a positive/negative pressure slope detecting module 133. The pressure amplitude detecting module 132 and the pressure level detecting module 131 receive the signal amplified by the pressure signal amplifying module 12 within 0.0001 second, the pressure level detecting module 131 filters the signal outside the pressure measuring range and the pressure amplitude detecting module 132 filters the signal of low pressure fluctuation as well as noise, thereby appropriately dealing with measurements for a variety of pressure environment variations. Subsequently, the pressure signal is transferred to the positive/negative pressure slope detecting module 133, then the positive/negative pressure slope detecting module 133 detects the pressure slope and slope change rate and filters the signal of low slope change. In case the pressure signal detected by the positive/negative pressure slope detecting module 133 exceeds a predetermined criteria value, the microprocessor 14 is activated within 0.0001 second;

a microprocessor 14, connected to the pressure signal amplifying module 12, pressure surge detecting module 13, timing module 15, network module 16 and memory 17, in which, when the signal detected by the positive/negative pressure slope detecting module 133 exceeds the criteria value, the microprocessor 14 is activated within 0.0001 second to perform continuous pressure value reading at 0.001 second and save to the memory 17. Following this, it sends the alarm message to a remote monitoring device 6 via the network module 16, or alternatively makes direct controls on the in-field apparatus, to undergo adequate emergent processes;

a timing module 15, connected to the microprocessor 14 to configure the pressure recording period such that the microprocessor 14 can automatically read continuous pressure values on the readable signal level inputted by the pressure signal amplifying module 12 at a certain fixed time point, and in case the predetermined criteria value is exceeded, the acquired pressure values will be stored to the memory 17;

a network module 16, connected to the microprocessor 14 and the remote monitoring device 6, in which the network module 16 includes a wired network module and a wireless network module thereby transferring the alarm message to the remote monitoring device 6 by way of a wireless network or wired network.

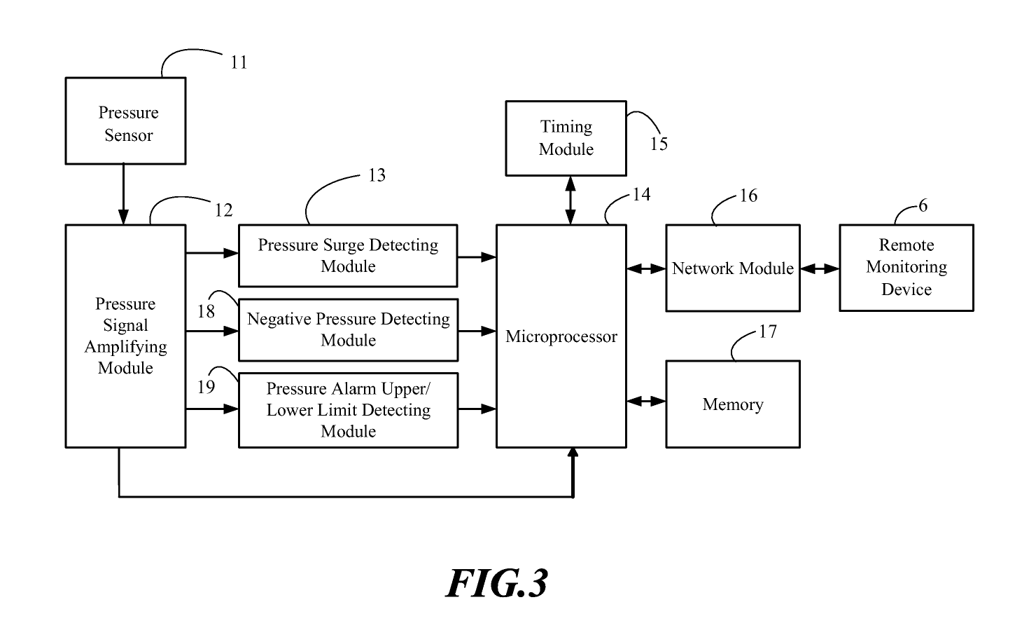

Refer next to FIG. 3, wherein a second architecture diagram for the abnormal pressure real-time monitoring and high speed recording device according to the present invention is shown. Compared with FIG. 2, the difference lies in that a negative pressure detecting module 18 and a pressure alarm upper/lower limit detecting module 19 are additionally installed between the pressure signal amplifying module 12 and the microprocessor 14. In accordance with the originally configured negative pressure and pressure alarm upper/lower limit criteria values, it is possible to detect, within 0.0001 second, the signal triggered by a negative pressure or by an alarm indicating that the pressure exceeds the upper/lower limit; hence, when the detected signal surpasses the criteria value (i.e., negative pressure criteria value or pressure alarm upper/lower limit criteria value), the microprocessor 14 will be activated within 0.0001 second. Other portions illustrated in the present architecture are identical to the counterparts shown in FIG. 2 and herein omitted for brevity.

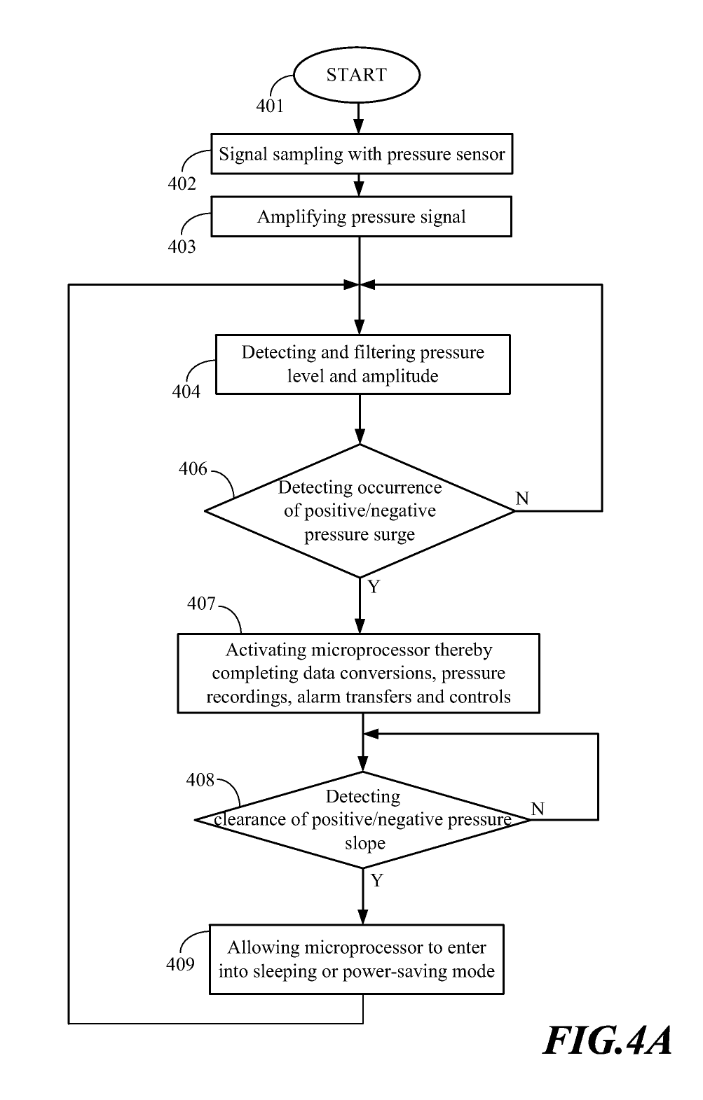

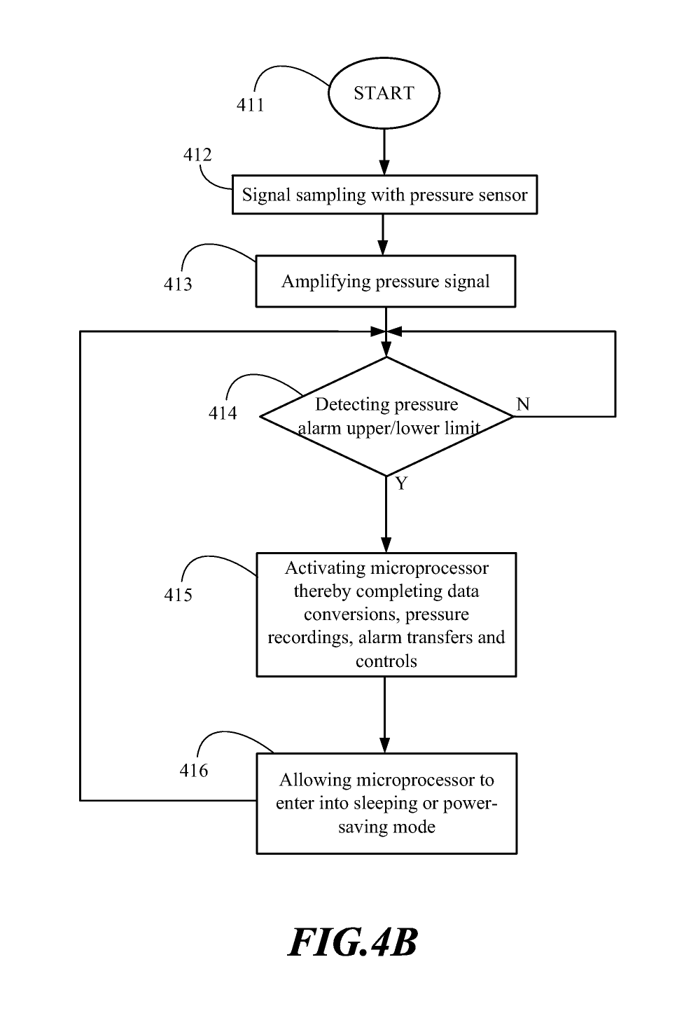

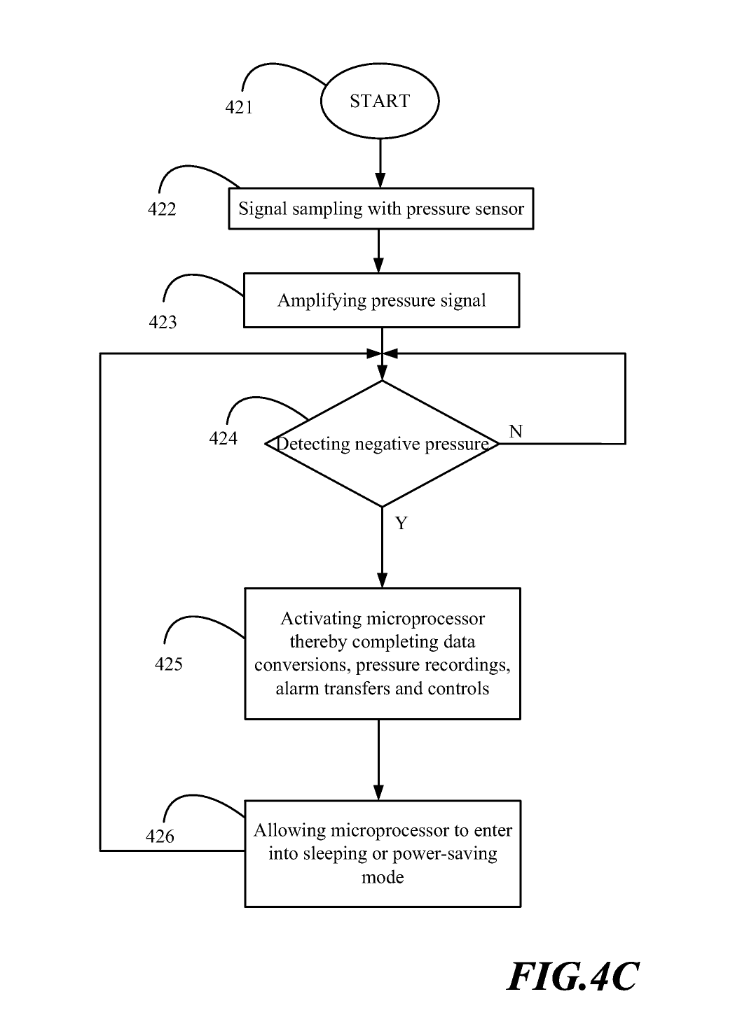

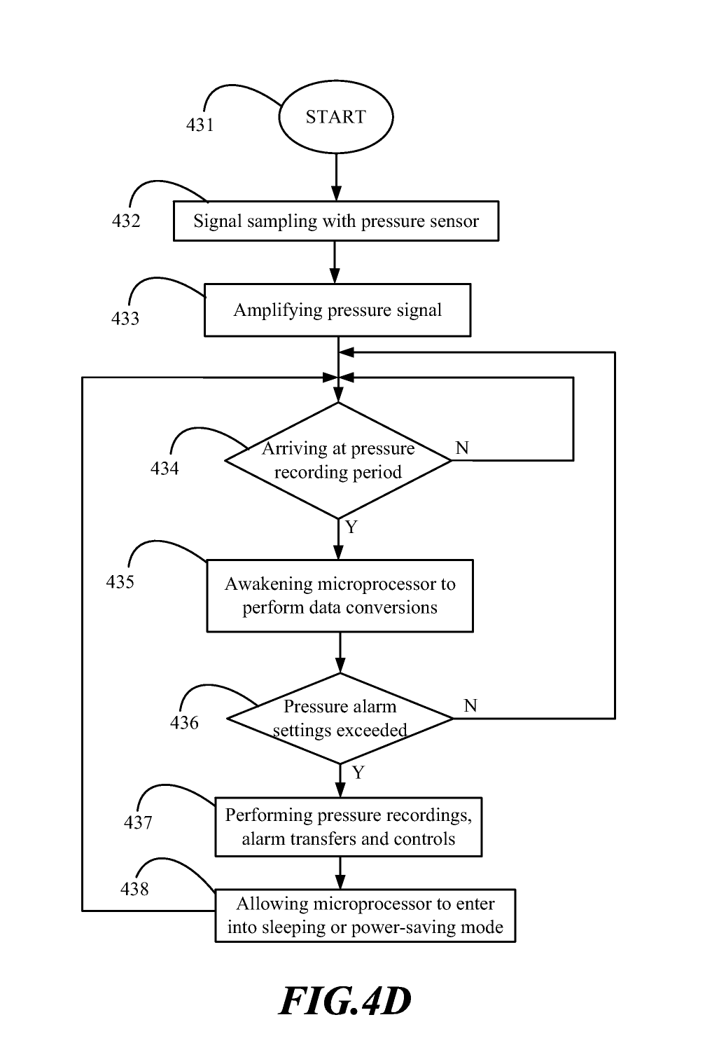

Refer now to FIG. 4A, wherein a flowchart for pressure slope detection according to the present invention is shown, comprising the flowing steps:

STEP 1: Starting to monitor the pressure slope detection 401, and then, through pressure detections by the pressure sensor, converting to the weak voltage signal 402;

STEP 2: Amplifying the voltage signal with the pressure signal amplifying module thereby converting to the readable signal level 403;

STEP 3: By means of the pressure level detecting module and the pressure amplitude detecting module, filtering the detected pressure measurement range as well as the signal of small fluctuation and noise 404;

STEP 4: Detecting the pressure slope and slope change with the positive/negative pressure slope detecting module and then filtering the signal of low slope change 406;

STEP 5: Awakening immediately the microprocessor within 0.0001 second in case that the signal detected by the positive/negative pressure slope detecting module exceeds the criteria value, and the microprocessor can, within 0.001 second, accomplish operations including data conversions, pressure slope recordings, alarm transfers and controls 407. On the other hand, returning to STEP 3 in case the signal detected by the positive/negative pressure slope detecting module does not exceed the criteria value;

STEP 6: Next, continuing the positive/negative pressure slope elimination detection 408. If the pressure slope is now reduced, indicating the situation is cleared, then the microprocessor accordingly enters into the sleeping mode; at the same time, the abnormal pressure real-time monitoring and high speed recording device continues the detection operations 409.

Refer then to FIG. 4B, wherein a flowchart for the present pressure alarm upper/lower limit detection is shown, comprising the following steps:

STEP 1: Starting to monitor the pressure alarm upper/lower limit detection 411, and then, through pressure detections by the pressure sensor, converting to the weak voltage signal 412;

STEP 2: Amplifying the voltage signal with the pressure signal amplifying module thereby converting to the readable signal level 413;

STEP 3: Performing detections with the pressure alarm upper/lower limit detecting module. In accordance with the originally configured pressure alarm upper/lower limit criteria values, it is possible to detect whether the pressure exceeds the pressure alarm upper/lower limit criteria values, and, in case the pressure exceeds the criteria value, awaken immediately the microprocessor within 0.0001 second 414. On the other hand, if the signal detected by the pressure alarm upper/lower limit detecting module does not exceed the criteria value, returning to START state at STEP 3;

STEP 4: Completing, by means of the microprocessor, operations including data conversions, pressure recordings, alarm transfers and controls 415;

STEP 5: Allowing the microprocessor to enter into the sleeping mode; meanwhile, the pressure alarm upper/lower limit detecting module continues its detections 416.

Refer subsequently to FIG. 4C, wherein a flowchart for the present negative pressure detection is shown, comprising the following steps:

STEP 1: Starting the pressure monitoring 421, and then, through pressure detections by the pressure sensor, converting to the weak voltage signal 422;

STEP 2: Amplifying the voltage signal with the pressure signal amplifying module thereby converting to the readable signal level 423;

STEP 3: Performing detections with the negative pressure detecting module. In accordance with the originally configured negative pressure criteria value, it is possible to detect whether the pressure exceeds the negative pressure criteria value; if the pressure exceeds the negative pressure criteria value, then the microprocessor is immediately activated within 0.0001 second 424. On the other hand, if the signal detected by the negative pressure detecting module does not exceed the criteria value, returning to START state at STEP 3;

STEP 4: Completing, by means of the microprocessor, operations including data conversions, pressure recordings, alarm transfers and controls 425;

STEP 5: Allowing the microprocessor to enter into the sleeping mode; meanwhile, the negative pressure detecting module continues its detections 426.

Refer subsequently to FIG. 4D, wherein a flowchart for the fixed-time pressure detection is shown, as illustrated, comprising the following steps:

STEP 1: Starting the pressure monitoring 431, and then, through pressure detections by the pressure sensor, converting to the weak voltage signal 432;

STEP 2: Amplifying the voltage signal with the pressure signal amplifying module thereby converting to the readable signal level 433;

STEP 3: Activating the microprocessor at fixed time points in accordance with the pressure recording period configured by the timing module 434, thereby allowing the microprocessor to complete the data conversions and recordings 435;

STEP 4: Determining then the occurrence of pressure alarm 436;

if the pressure exceeds the alarm settings, performing within 0.001 second operations including pressure recordings, alarm transfers and controls 437;

STEP 5: Finally, allowing the microprocessor to enter into the sleeping mode; meanwhile the timing module continues its timing operation 438.

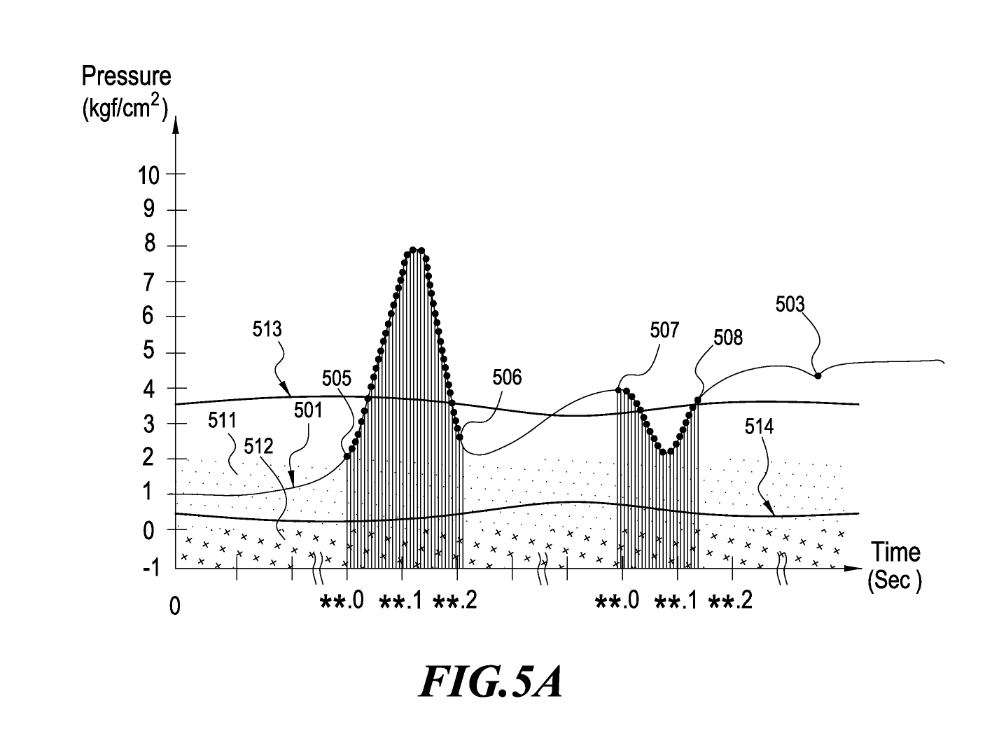

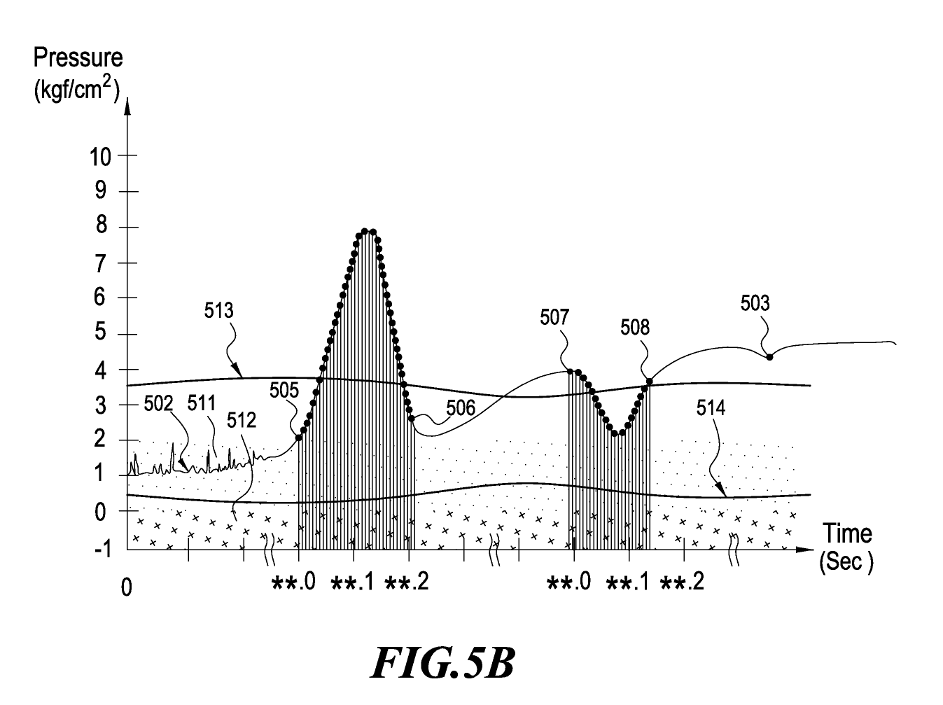

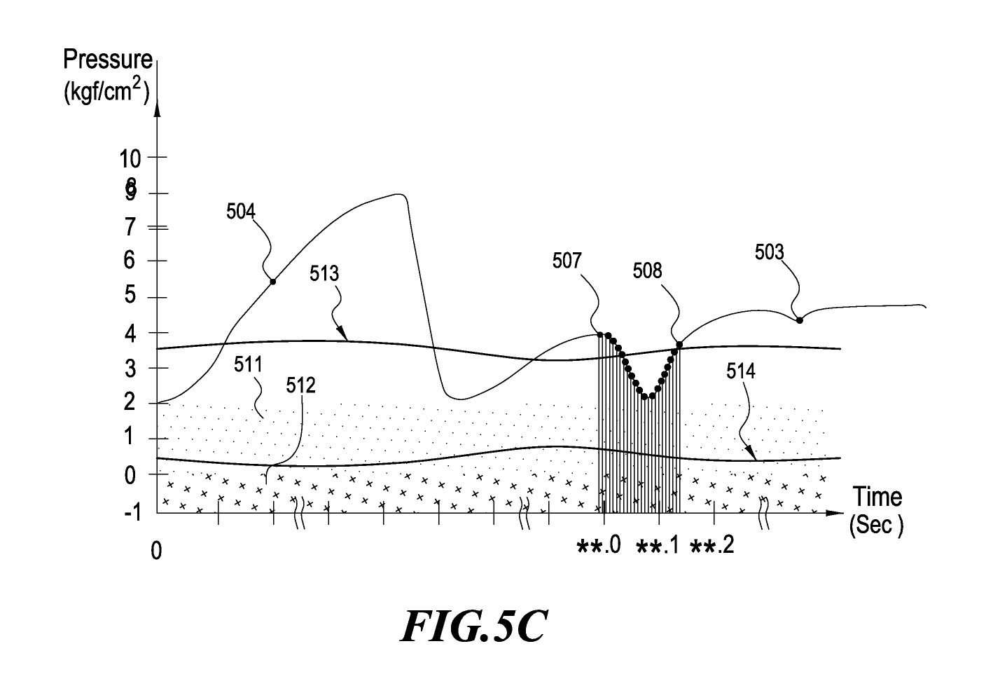

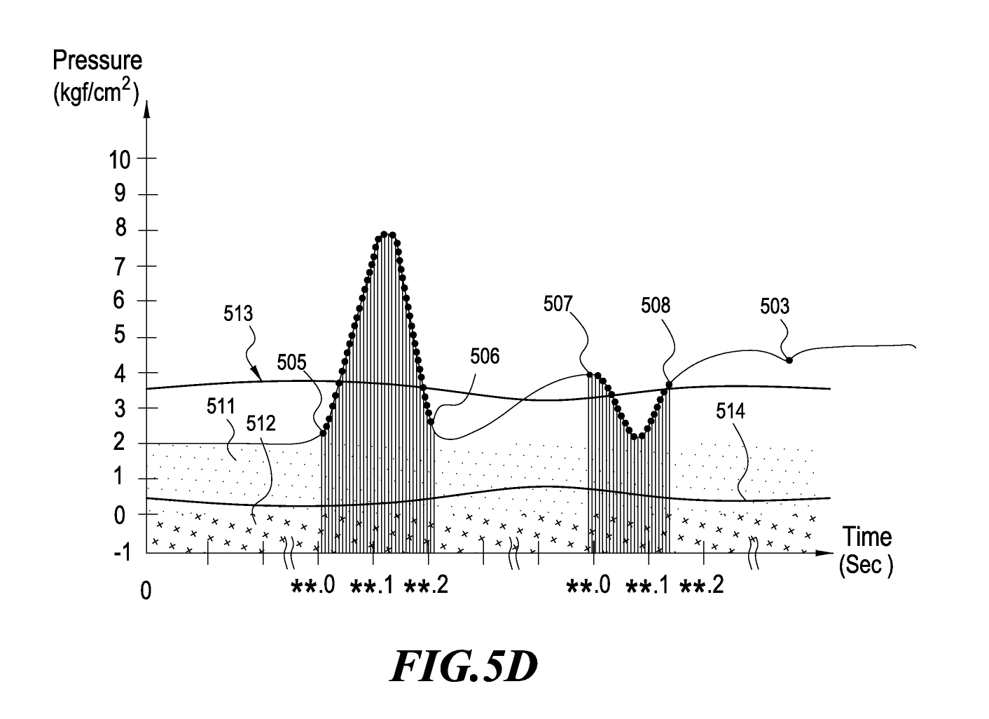

Now refer conjunctively to FIG. 3 and FIGS. 5A-D, wherein the diagrams show the configuration for the settings of pressure level, amplitude detection, negative pressure detection range and pressure alarm upper/lower limit, as below:

1. The pressure level and amplitude filter range 511 are set to be within 0˜2 Kgf/cm²;

2. The negative pressure detection range 512 is set to be below 0 Kgf/cm²;

3. The pressure alarm upper limit 513 is set to be 3.3˜3.7 Kgf/cm² and the pressure alarm lower limit 514 is 0.3˜0.6 Kgf/cm². Moreover, the pressure level and amplitude detection 511, negative pressure detection 512, pressure alarm upper limit 513 and pressure alarm lower limit 514 may be curves or straight lines varying along time, and such detections can be adjusted, configured or even cancelled through software or hardware.

As shown in FIGS. 5A-D, when the pressure surge detecting module 13 acquires the pressure measurement range signal 501 (as shown in FIG. 5A) or small pressure fluctuation signal 502 (as shown in FIG. 5B) within 0˜2 Kgf/cm², or else detects the pressure amplitude signal 503 (as shown in FIGS. 5A˜D), such signals 501, 502 and 503 are filtered. Subsequently, the pressure slope and pressure slope change rate are detected, and when the positive pressure slope abnormal signal point 505 and negative pressure slope abnormal signal point 507 are detected, the microprocessor 14 will be awakened immediately within 0.0001 second to perform continuous signal pressure reading at 0.001 second and save to the memory 17. Following this, it transfers the alarm message to a remote monitoring device 6 via the network module 16, or alternatively makes direct controls on the in-field apparatus, to undergo adequate emergent processes. Such operations continue, until the positive pressure slope disappearance signal point 506 or negative pressure slope disappearance signal point 508 is detected, thereby allowing the microprocessor 14 to enter into the sleeping mode.

Furthermore, as shown in FIG. 5C, if the pressure surge detecting module 13 determines the slope signal is a normal slope signal 504, then it filters the slope signal 504 and concludes this is a normal pressure.

Also, if the negative pressure detecting module 18 detects a negative pressure signal below 0 Kgf/cm², the microprocessor 14 will be awakened within 0.0001 second as well.

In addition, suppose the pressure alarm upper/lower limit detecting module 19 detects a pressure signal below 0.3˜0.6 Kgf/cm² or above 3.3˜3.7 gf/cm², then the microprocessor 14 will be similarly awakened within 0.0001 second.

Besides, detections on positive/negative pressure slope and slop change by the pressure surge detecting module 13 may be curves or straight lines varying along time, and such detections can be adjusted, configured or even cancelled through software or hardware.

Moreover, the aforementioned settings simply represent the preferred embodiments of the present invention, rather than used to restrict the scope of the present invention thereto.

Compared with other conventional technologies, the abnormal pressure real-time monitoring and high speed recording device according to the present invention provides the following advantages:

1. The present invention can monitor and process in real time the pressure in a closed space such as a pipeline or a tank, and determine whether the detected pressure exceeds the criteria value in order to awaken the microprocessor to enable the high speed activating, alarming, recording and controlling mechanism.

2. The microprocessor of the present invention is in a stand-by sleeping mode under normal conditions. In case that a high speed surge pressure, negative pressure, or condition indicating the upper/lower pressure limit is exceeded is detected, it is possible to awaken the microprocessor within 0.0001 second to send out an alarm and record the pressure waveform at high speed of 0.001 second, thus allowing greatly improving the problems of massive consumption in both electric power and memory capacity for high speed scanning and recording with conventional microprocessors.

3. The present invention allows the use of 5AH lithium batteries for continuous applications of long duration lasting at least 3˜5 years, so the pressure monitoring and recording locations need not electric power supply. In this way, it is possible to facilitate installation cost reductions for pressure monitoring on important pipelines and tanks or the like and acquire high speed surge records which are crucial to pipeline security issues.

4. The present invention can be comprehensively applied to various facilities equipped with the closed space such as gas pipelines, oil pipelines, water supply pipelines, storage tanks and so forth, allowing 0.0001 second real-time monitoring and high speed pressure change recording at 0.001 second.

Through the aforementioned detailed descriptions for the preferred embodiments of the present invention, it is intended to better illustrate the characteristics and spirit of the present invention rather than restricting the scope of the present invention to the preferred embodiments disclosed in the previous texts. On the contrary, the objective is to encompass all changes and effectively equivalent arrangements within the scope of the present invention as delineated in the following claims of the present invention.

What is claimed is:

1. An abnormal pressure real-time monitoring and high speed recording device, characterized in comprising:
a pressure sensor, converting the pressure to a voltage signal;
a pressure signal amplifying module, connected to a pressure surge detecting module in order to amplify the voltage signal converted by the pressure sensor thereby converting to a readable signal level;
a pressure surge detecting module, connected to the pressure signal amplifying module and a microprocessor in order to filter pressure level, pressure amplitude, and to detect the occurrence and elimination of positive/negative pressure slope, as well as to adjust and set the pressure level, amplitude, slope and slope change;
a microprocessor, connected to the pressure signal amplifying module and the pressure surge detecting module, and, upon detecting an abnormal pressure signal by the pressure surge detecting module, awakened to activate in real time so as to read high speed continuous pressure values and save them in the memory.

2. The abnormal pressure real-time monitoring and high speed recording device according to claim 1, characterized in: further comprising a timing module, connected to the microprocessor and setting the pressure recording and detecting period in order to allow the microprocessor to process the signal inputted by the pressure signal amplifying module and to read the pressure values at fixed time points thereby determining the occurrence of a pressure alarm, thus immediately saving the pressure values in the memory in case that the pressure exceeds the alarm settings.

3. The abnormal pressure real-time monitoring and high speed recording device according to claim 1, characterized in: further comprising a network module, connected to the microprocessor in order to send the alarm message to a remote monitoring device through a wireless network or a wired network.

4. The abnormal pressure real-time monitoring and high speed recording device according to claim 1, characterized in: the pressure surge detecting module includes a pressure level detecting module, a pressure amplitude detecting module and a positive/negative pressure slope detecting module.

5. The abnormal pressure real-time monitoring and high speed recording device according to claim 1, characterized in: the pressure surge detecting module is a detecting module for high speed scanning pressure signal, which enables a detecting rate of smaller than 0.0001 second per cycle and a recording rate of lower than 0.001 second per cycle.

6. An abnormal pressure real-time monitoring and high speed recording device, characterized in comprising:
a pressure sensor, converting the pressure to a voltage signal;
a pressure signal amplifying module, connected to a pressure surge detecting module in order to amplify the voltage signal converted by the pressure sensor thereby converting to a readable signal level;
a pressure surge detecting module, connected to the pressure signal amplifying module and a microprocessor in order to detect the occurrence and elimination of positive/negative pressure slope, as well as to adjust the filtered pressure level, amplitude and the magnitude of the detected slope and slope change;
a negative pressure detecting module, installed between the pressure signal amplifying module and the microprocessor to set the negative pressure criteria value, and capable of detecting the pressure to determine whether the criteria value is exceeded thereby further awakening the microprocessor to activate;
a microprocessor, connected to the pressure signal amplifying module and the pressure surge detecting module, and, upon detecting an abnormal pressure signal by the pressure surge detecting module and the negative pressure detecting module, awakened to activate in real time so as to read high speed continuous pressure values and save them in the memory.

7. The abnormal pressure real-time monitoring and high speed recording device according to claim 6, characterized in: the pressure surge detecting module includes a pressure level detecting module, a pressure amplitude detecting module and a positive/negative pressure slope detecting module.

8. An abnormal pressure real-time monitoring and high speed recording device, characterized in comprising:
a pressure sensor, converting the pressure to a voltage signal;
a pressure signal amplifying module, connected to a pressure surge detecting module in order to amplify the voltage signal converted by the pressure sensor thereby converting to a readable signal level;
a pressure surge detecting module, connected to the pressure signal amplifying module and a microprocessor in order to detect the occurrence and elimination of positive/negative pressure slope, as well as to adjust the pressure high/low level and the magnitude of the slope change;
a pressure alarm upper/lower limit detecting module, installed between the amplifying module and the microprocessor to set the pressure alarm upper/lower limit criteria value, and capable of detecting the pressure to determine whether the criteria value is exceeded thereby further triggering the microprocessor to activate;
a microprocessor, connected to the pressure signal amplifying module and the pressure surge detecting module and the pressure alarm upper/lower limit detecting module, and, upon detecting an abnormal pressure signal by the pressure surge detecting module and the pressure alarm upper/lower limit detecting module, awakened to activate in real time so as to read high speed continuous pressure values and save them in the memory.

9. The abnormal pressure real-time monitoring and high speed recording device according to claim 8, characterized in: the pressure surge detecting module includes a pressure level detecting module, a pressure amplitude detecting module and a positive/negative pressure slope detecting module.
